(19) United States
(12) Patent Application Publication
(10) Pub. No.: US 2006/0156991 A1
(43) Pub. Date: Jul. 20, 2006

(54) Litter scoop and caddy

(75) Inventors: Mary V. Burns, Union, KY (US); Christopher P. Howard, Reno, NV (US)

Correspondence Address: KLARQUIST SPARKMAN, LLP, 121 SW SALMON STREET, SUITE 1600, PORTLAND, OR, 97204, US

(73) Assignee: Veterinary Ventures, Inc.

(21) Appl. No.: 11/281,044

(22) Filed: Nov. 16, 2005

Related U.S. Application Data
(60) Provisional application No. 60/644,109, filed on Jan. 14, 2005.

(51) Int. Cl. A01K 29/00

(52) U.S. Cl. 119/161

(57) ABSTRACT

Certain embodiments provide a litter scoop having a sifting basket formed from a bottom, an open front portion, two lateral sides, and a back. A handle is operatively coupled to the sifting basket. A plurality of apertures of different sizes are formed in the bottom of the sifting basket. A user may grasp the litter scoop by the handle and move the litter scoop through litter in order to separate used litter and animal waste from unused litter. Further embodiments provide a litter scoop with a comfortable handle. The handle may have one or more soft comfort grips affixed to a central handle core.

### CROSS REFERENCE TO RELATED APPLICATION

This application claims the benefit of, and incorporates by reference, U.S. Provisional Patent Application No. 60/644,109, filed Jan. 14, 2005.

### TECHNICAL FIELD

The present application relates generally to litter scoops and litter scoop caddies. In particular, some of the disclosed litter scoops have improved litter sifting and grip properties.

### BACKGROUND

Litter in specialized boxes or pans is used by the vast majority of owners of cats and certain other indoor pets as a means to provide acceptable elimination of the waste products of these pets. A commonly used type of litter is classified as “clumping,” which means that liquid waste, such as urine, forms a ball of litter which may then be scooped neatly from the box along with solid waste. Prior to the advent of clumping litter, there was no means to effectively isolate and remove the liquid waste, and so a complete change of litter was required.

The litter balls and the solid waste are sifted out of the box with a litter scoop, and any unused litter scooped up with the waste filters out of the scoop's basket through apertures, which can help prevent wasting unused litter.

Prior litter separation technology typically suffers from a number of problems. One such problem is that liquid waste sometimes does not form a solid or complete ball. It is not uncommon for the liquid waste to instead form a small puddle. In cats with certain diseases, such as chronic renal failure or diabetes, the volume of urine produced can be greatly increased, forming a very large puddle. Another problem occurs when liquid waste, litter balls, or other waste sticks to the bottom or especially the sides of a litter box, where it must be scraped off prior to sifting out. This is especially true when a diseased cat has produced a large puddle, which tends to stick much more than under normal circumstances.

Manipulation of the masses of waste prior to sifting (e.g., by raking or scraping to aggregate waste) often results in breakage of the masses and the formation of small pieces of waste which fall through the relatively large, one-sized apertures of typical prior litter scoops. Therefore the litter, containing small clumps of waste which cannot be removed with these litter scoops, remains soiled. This may result in more bacteria remaining in the box, an increase in acrid and other unpleasant odors from the box, and the increased expense of replacing the litter more frequently than would be otherwise required. In addition, the animal may refuse to use the box and soil the living area.

A few prior litter scoops contain apertures of a smaller size than the rest of the prior litter scoops. These smaller aperture scoops are typically more effective in removing the small pieces of waste, therefore leaving the litter cleaner and more sanitary. However, the small size of the apertures often causes the filter time of the loose litter to be excessively long, and it is undesirable that this chore be more time consuming than necessary. The small apertures are often small in only one dimension and still may have a relatively large area, reducing their ability to retain small pieces of waste. There are typically also a relatively small number of apertures per unit area of the scoop, which may also contribute to long sift times.

Typical litter scoops suffer from a number of additional problems. The handles of many litter scoops are uncomfortable to grip. The handles are often relatively short and force the user to be in close proximity to the litter. The handles may also force the user to assume an uncomfortable position when scooping litter.

Another problem with typical litter scoops is where to store the litter scoop when it is not in use. It can be distasteful to have a litter scoop lying in plain sight. In addition, debris may fall off used litter scoops, potentially creating a mess or an unsanitary condition.

There has been some effort to create holders for litter scoops. For example, U.S. Pat. No. 6,578,807 purports to disclose a cat litter scoop holder having a base to provide stability for the holder when it is disposed on a horizontal surface and which may have a bracket for mounting the holder to a vertical surface. However, typical prior litter scoop holders, including that of U.S. Pat. No. 5,578,807, are inconvenient to transport.

### SUMMARY

The present application relates to litter scoops and litter scoop caddies. Certain embodiments facilitate effective scooping for the removal of liquid waste. In particular, certain embodiments of the litter scoop contain draining apertures of more than one size within the same sifting basket. One implementation has draining apertures of two different sizes, but any number of different sizes may be used as is practical, such as three or four. In a further implementation, the different sized apertures are segregated into separate areas of a sifting basket. Properly used, these tools capture small clumps of waste with smaller apertures but reduce filter time of unused litter by the larger apertures. In further embodiments, the smaller apertures are selectively contacted with the litter to remove small pieces of waste, but contact with the larger apertures is substantially avoided in order to prevent the small pieces of waste from passing through the larger apertures.

Accordingly, these embodiments may result in a cleaner litter box than was previously possible without the long sift time of typical small aperture litter scoops. A cleaner litter box is more sanitary for both pets and their owners and may reduce undesirable odor.

At least one embodiment of the litter scoop includes a sifting basket having a bottom having a plurality of apertures of different sizes, an open front portion, two sides, and a back. A handle is operatively coupled to the sifting basket. The sifting basket may be constructed from any suitable material.

In certain examples, the bottom of the sifting basket has small apertures each having an area of about 36 mm² or less (such as about 25 mm² or less), where the apertures are square apertures having sides of about 6 mm or less (such as about 5 mm or less). In certain examples, the bottom of the sifting basket also has large apertures having an area of about 36 mm² or more (such as about 49 mm² or more), where the apertures are square apertures having sides of about 6 mm or more, such as about 7 mm or more. Alternatively, the apertures have other sizes and/or shapes.

In at least one embodiment, the bottom of the sifting basket includes a mesh or meshes. In various examples, the mesh is apertures formed in a solid surface. Or, the mesh is made of metal wire, such as stainless steel wire, or wire made from a synthetic material, including plastics such as ABS, polypropylene, polyethylene, and nylon. In a particular implementation, one section of the bottom has wire of a first diameter or gauge and of a first number of apertures per inch, and a second section of the bottom has wire of a second diameter or gauge and of a second number of apertures per inch, resulting in two different sizes of apertures or openings in the two sections for capturing and draining litter and waste. Other embodiments may differ in either the diameter or gauge or the number of apertures per inch of the sections, or differ in both diameter/gauge and number of apertures, or mix holes of different sizes in a given section of the bottom. In a particular implementation, a first section of the bottom has a first number of wires per inch and a second section of the bottom has a second number of wires per inch, resulting in two different sizes of apertures in two sections for capturing and draining litter and waste.

In particular embodiments, the litter scoop includes adjustable apertures. In one implementation, adjustable apertures are created from the interaction of moveable wires with fixed wires. For example, the movable wires may be attached to a moveable shaft and a user can select the size of the apertures by moving the moveable wires relative to the fixed wires. A button, lever, or similar device can be provided to aid the user in selecting the aperture size. In further embodiments, the litter scoop includes a plurality of regions of adjustable apertures, such as regions having independently adjustable apertures. In yet further embodiments, the litter scoop includes a region of adjustable apertures and a region of fixed apertures.

Certain embodiments of the litter scoop include a raised strip of material between areas of different sized apertures on the bottom of the sifting basket, which may prevent small clumps of waste captured by smaller apertures from rolling back into an area of larger apertures. In some embodiments, the strip of material is minimally raised so as to block clumps of waste, but not interfere with the conduction of unused litter from the front of the litter scoop to the rear of the litter scoop.

Certain embodiments provide a litter scoop with a handle ergonomically designed for comfort and efficiency. In some embodiments, the handle has soft rubber inserts on the sides of the handle. The soft rubber inserts may provide for a more comfortable and/or secure grip on the litter scoop handle. In some examples, the soft rubber inserts may be coupled to the sides of the handle and extend to upper and lower surfaces of the handle. In at least some implementations, the rubber inserts do not extend across at least one of the top and bottom surfaces of the handle. In certain embodiments, the soft rubber inserts extend substantially the length of the handle, such as at least about 60% of the handle's length, such as at least about 66%, 75%, 80%, 90%, or greater than 90% of the handle's length.

Certain embodiments of the litter scoop include a handle with an ergonomic curve. In some implementations, the handle has a serpentine curve. For example, the handle may have a first concave portion proximate a sifting basket and a second convex portion closer to a tapered end of the litter scoop handle. In a further example, the first concave portion of the handle extends above the sifting basket of the litter scoop.

At least one embodiment is directed to a litter scoop having a handle which enables a user to keep a greater distance between himself/herself and a litter box during cleaning. The handle is relatively long compared to prior litter scoops. For example, in one implementation the handle is approximately 14 inches long. Moreover, in some cases, the handle is joined to the sifting basket at an angle such that the handle is raised above the horizontal plane of the sifting basket.

Certain embodiments provide a litter scoop with a scraping edge. The scraping edge may be constructed of any suitable hard material, for example, stainless steel. The scraping edge may help a user dislodge waste that has stuck to the surface of a litter box. The scraping edge may be located on any suitable surface of the litter scoop, including the front of the litter scoop or a side. In some examples, a metal scraping edge is coupled to a plastic portion of a sifting area.

At least one embodiment provides a litter scoop that has steep solid sides. The steep solid sides preferably act as a self-feeding mechanism to speed the passage of scooped unused litter to a rear portion of the sifting basket.

Certain embodiments provide the means to suspend the litter scoop upon a mount when the scoop is not in use. For example, in some cases, a hanging hole is formed in the handle.

Further embodiments provide a litter scoop caddy. A litter scoop may be stored in the litter scoop caddy when the scoop is not in use. In some embodiments of the caddy, the litter scoop caddy has a curved front section and an at least substantially flat back section that define a central cavity.

In some embodiments, the litter scoop caddy has a bottom stability foot for free standing storage on a horizontal surface. For example, the bottom stability foot is a curved portion flaring outward from at least a portion of the front and back sections of the litter scoop caddy.

The litter scoop caddy may have hanging holes formed therein for allowing the litter scoop caddy to be mounted on a vertical surface. For example, a mounting flange may extend from the back section of the caddy and have one or more hanging holes formed therein.

Certain embodiments provide a litter scoop caddy having a handle for transporting the litter scoop caddy. Some embodiments provide a litter scoop caddy having an ergonomically curved handle. Further embodiments provide a litter scoop caddy with a handle having a gripping section on an inner surface of the handle. In one implementation, the gripping section includes a semicircular indention in the inner surface of the handle.

The litter scoops and caddies described herein are typically simple and economical to manufacture, of durable construction, and of a practical price for sale to the public.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above.

### BRIEF DESCRIPTION OF THE DRAWINGS

Various embodiments are shown and described in connection with the following drawings in which:

FIG. 1 is a front perspective view of a multiple sized aperture litter scoop with an ergonomic handle.

FIG. 2 is an elevational view of the litter scoop of FIG. 1.

FIG. 3 is a front perspective view of a litter scoop caddy which may be used to hold the litter scoop of FIG. 1.

FIG. 4 is a rear perspective view of the litter scoop caddy of FIG. 3.

FIG. 5 is a front perspective view of the litter scoop of FIG. 1 in use with the litter scoop caddy of FIG. 3.

FIGS. 6A-6C are views of a litter scoop having adjustable apertures. FIG. 6A is a perspective view of such a litter scoop. FIG. 6B is an exploded view of the adjustable apertures of the litter scoop of FIG. 6A. FIG. 6C is a close up view of an alternate sifting area that can be used with the litter scoop of FIG. 6A.

FIG. 7 is an elevational view of a litter scoop having adjustable apertures formed by wires connected by pins to a track in the litter scoop.

### DETAILED DESCRIPTION

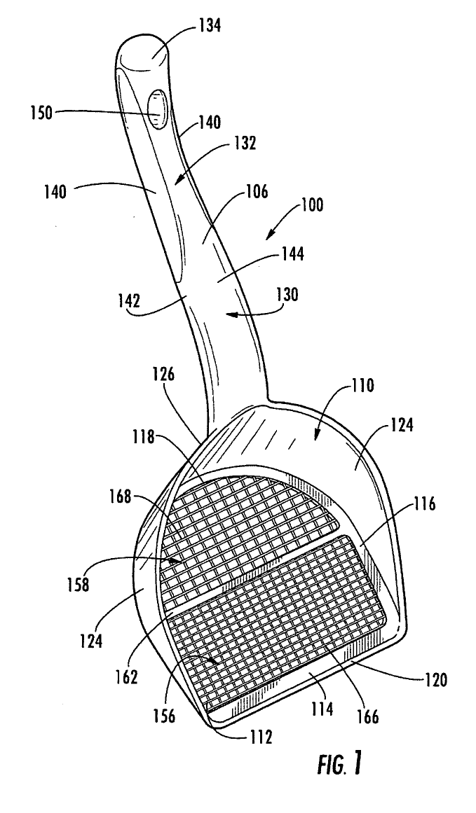

FIG. 1 illustrates a litter scoop 100. The litter scoop 100 has a handle 106 coupled to a sifting basket 110.

The sifting basket 110 is formed from a planar bottom section 112 having a straight front portion 114 and two lateral sides 116. The two lateral sides 116 of the bottom section 112 are straight towards the front portion 114 of the bottom section 112 and then curve inwardly towards each other to form the rear portion 118 of the bottom section 112. Therefore, the bottom section 112 is a half-obround. Alternatively, the bottom section 112 has another shape, for example a half oval or a rectangle, and may be non-planar.

The bottom section 112 may be integrally formed in the sifting basket 110 or may be one or more separate pieces coupled to the sifting basket 110. In at least one embodiment, the planar bottom section 112 is coupled to the sifting basket 110 by a tongue and groove mechanism and may be further secured by other means, such as gluing. Alternatively, another connection mechanism may be used.

The bottom section 112, and other parts of the sifting basket 110, may be constructed of any suitable material, preferably plastics, including standard commercial plastics such as ABS or polypropylene.

A scraping surface 120 may be formed on, or coupled to, the front portion 114. The scraping surface 120 may be formed from any suitable material, preferably a suitably hard material, such as plastic, galvanized steel, or stainless steel. The scraping surface 120 may be smooth or serrated, or have another form. Although FIG. 1 shows the scraping surface on the front 114, the scraping surface could be located on a side 116 or may lack a scraping surface.

The sifting basket 110 further contains two lateral sides 124 extending perpendicularly upwards from the bottom section 112. Like the lateral sides 116 of the planar bottom section 112, the lateral sides 124 are straight towards the front portion 114 of the bottom section 112 and then curve inwardly towards each other at the rear portion 118 of the bottom section 112. The lateral sides 124 are tapered such that the lateral sides 124 are the highest at the rear 126 of the sifting basket 110 and then taper downward along the straight portions of the lateral sides 116 of the bottom section 112 to join the front portion 114 of the bottom section 112. Alternatively, the lateral sides 124 of the sifting basket 110 have another shape.

The handle 106 extends from the rear 126 of the sifting basket 110. The handle 106 and the sifting basket 110 may be separate pieces that are joined together or may be integrally formed. In at least one embodiment, the handle 106 and the sifting basket 110 are coupled by a tongue and groove mechanism and may be further secured to one another by other means, such as gluing. Alternatively, another connection mechanism is used. The handle 106 may be constructed from any suitable material, including plastics or rubber.

Portion 130 of the handle 106 curves concavely upward from the sifting basket 110 and extends above the top of the sifting basket 110. Portion 132 of the handle 106 curves convexly downward and then upward and tapers off to the end 134 of the handle 106. Alternatively, the handle 106 has a different shape, for example, straight or relatively straight.

An aperture 150 is formed proximate the tapered end 134 of the handle 106. Alternatively, the aperture 150 is formed elsewhere or the handle 106 lacks an aperture 150.

Gripping sections 140 are coupled to each lateral side 142 of the handle 106 and extend to the upper 144 and lower (not shown in FIG. 1) surfaces of the handle 106. The gripping sections 140 may be formed from any suitable material, such as plastics or rubber. Gripping sections 140 of soft rubber are presently preferred. In certain examples, the soft rubber inserts 140 extend substantially the length of the handle 106, such as at least about 60% of the handle's length, such as at least about 66%, 75%, 80%, 90%, or greater than 90% of the handle's length. Alternatively, the handle 106 lacks gripping sections 140, or the gripping sections 140 are placed elsewhere on the handle 106.

The bottom section 112 of the sifting basket 110 has a front aperture area 156 and a rear aperture area 158. The front aperture area 156 is shown as a quadrilateral while the rear aperture area 158 is shown as a semi-circle having its diameter proximate the length of the front aperture area 156, however any suitable shapes may be used for the front and rear aperture areas 156, 158. Moreover, the bottom section 112 may include more aperture areas than two, or a mix a different size apertures in a single aperture area. Or, for example, in scoops with an ergonomically shaped or constructed handle, as described herein, the bottom section 112 may include a single aperture area with apertures of a single size.

In FIG. 1, the front aperture area 156 and the rear aperture area 158 are separated by a separating strip 162 of the bottom section 112. The separating strip 162 may be raised from the surface of the bottom section 112. Alternatively, material (not shown), such as a rubber strip or strip made of similar material, can be coupled to the separating strip 162 or bottom 112 in order to create a raised surface separating the front 156 and the rear 158 aperture areas. Or, the bottom 112 may lack a separating strip. For scoops with more and/or differently arranged aperture areas, separating strips may be placed as needed.

Mesh or screening material 166, 168 is located within the front aperture area 156 and the rear aperture area 158, respectively. As used herein, the term “mesh” refers to a network formed from the interaction of a plurality of wires, strips, threads, cords, strings, ropes, or similar materials (unless the context clearly indicates otherwise, these materials are collectively referred to as “wires”), or formed by perforations or openings in a surface. In certain implementations, a first plurality of parallel wires intersect a second plurality of parallel wires, the first plurality of wires being perpendicular to the second plurality of wires.

The mesh or screening material 166, 168 can be made from any suitable material, including plastics and metals. For example, the mesh 166, 168 is stainless or galvanized steel wire. In other examples, the mesh 166,168 may formed from wire made from a synthetic material, including plastics such as ABS, polypropylene, polyethylene, and nylon. The surface of the wire may be rounded or flat, and may depend on the material from which the wire is made. Or, the mesh may be formed by perforations or openings in material, such as apertures formed in a plastic surface or sheet metal. The mesh 166, 168 can be a separate material that is coupled to the bottom section 112 or may be integrally formed in the bottom section 112.

The mesh 166 covering the front aperture area 156 includes apertures of a different size than the mesh 168 covering the rear aperture area 158. The density and size of the apertures can be changed by altering the size of the wires (the gauge or denier of the wire) forming the mesh or by changing the number of wires per unit area. In FIG. 1, the mesh 168 has larger apertures than the mesh 166. For example, the mesh 168 may have openings that have an area of at least about 36 mm², such as about 49 mm² for substantially square openings having sides of about 7 mm. The mesh 166 may have openings that are about 36 mm² or less, such as 25 mm² for substantially square openings having sides of about 5 mm. In a particular example, the mesh 168 has openings of about 40 mm² to about 60 mm² and the mesh 166 has opening of about 16 mm² to about 30 mm². The apertures may have shapes other than squares, such as round openings in non-mesh apertures areas, and certain embodiments may have apertures with larger or smaller areas than the specifically disclosed examples.

In use, a user may grip the litter scoop 100 by the handle 106 and insert the sifting basket 110 into a quantity of litter. A portion of the litter is picked up by the litter scoop 100 and the user moves the litter scoop 100, preferably in a side to side manner, to move the litter over the front and rear aperture areas 156, 158. When the mesh 166 covering the front aperture area 156 has smaller apertures than the mesh 168 covering the rear aperture area 158, smaller pieces of broken animal waste can be captured on the front mesh 166 while unused litter can be shaken and quickly sifted out of the sifting basket 110 through the larger apertures of the rear mesh 168. The filter time of litter from the litter scoop 100 is thereby reduced compared to litter scoops having only relatively smaller apertures. In some instances, small pieces of waste may be removed by gathering the small pieces of waste onto smaller apertures without shaking the litter scoop 100, thus preventing the small pieces of waste from passing through larger apertures.

During sifting, when a raised separating strip 162 is used, the raised separating strip 162 between the front and rear aperture areas 156, 158 acts as a barrier to clumps of waste when the litter scoop 100 is tilted upwards (raising the basket 110).

When the litter scoop 100 is not being used, a user may choose to store the litter scoop 100 by hanging the litter scoop 100 from a protrusion, such as a nail, a hook, or peg, inserted through the aperture 150. The rubber inserts 140 of the handle 106 may provide the user with a comfortable and secure grip while using the liter scoop 100. The user may use the scraping edge 120 to remove waste or litter adhering to the surface of the litter container.

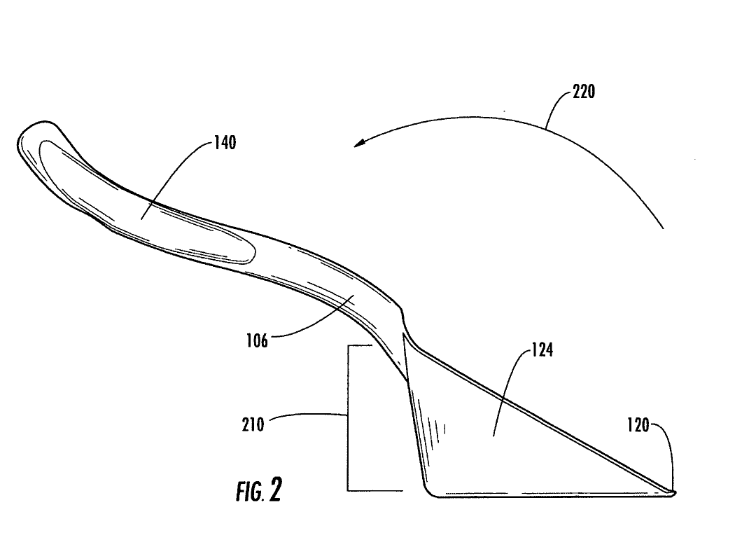

Turning to FIG. 2, an alternate view of the litter scoop 100 of FIG. 1 is shown. It can be seen that the handle 106 is relatively long. Using a relatively long handle 106 may enable a user to create greater distance between himself/herself and soiled litter, increasing sanitation and decreasing the discomfort of a bent-over posture. The serpentine curve created by convex and concave handle portions 132, 130, for example, also may increase the user's comfort while using the litter scoop 100.

As can be seen in FIG. 2, the angle 210 formed where the handle 106 attaches to the sifting basket 110 results in a user's hand being raised above the sifting basket 110, which increases the distance between the user's hand and the pet's waste and increases sanitation. Alternatively, the handle 106 may be attached to the sifting basket 110 at a different location and/or angle.

Arrow 220 shows the tilt of the litter scoop 100 after scooping up a quantity of used litter, so as to take advantage of multiple-sized apertures. Namely, small pieces of broken waste may be captured by the smaller apertures and the loose unused litter may drain more rapidly through the larger apertures.

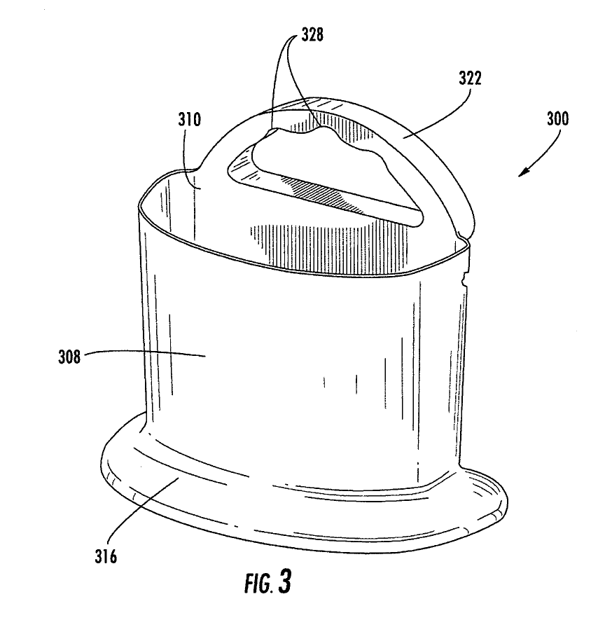

FIG. 3 illustrates a litter scoop caddy 300. The caddy 300 is designed to hold the litter scoop 100 (FIG. 1) when it is not in use.

The caddy 300 has a curved front wall 308 that joins a substantially flat back wall 310 to form a central chamber. A bottom portion of the caddy 300 is flared outward from the front wall 308 and the back wall 310 and forms a foot 316. The foot 316 may be separate from the front and back walls 308, 310 and attached thereto, or it may be integrally formed therefrom. Alternatively, the caddy has a different shape.

A curved handle 322 extends upwardly from the back wall 310. The curved handle 322 may be integrally formed from the back wall 310 or a separate piece coupled thereto. The curved handle 322 has a plurality of semi-circular curved indentions 328 formed in the inside of the curved handle 322 to aid a user in gripping the handle 322. Alternatively, the handle is located elsewhere on the caddy or has a different shape, or the caddy lacks a handle.

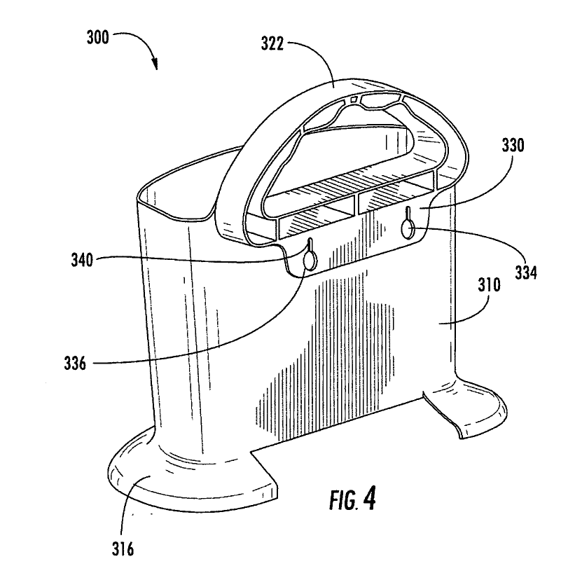

FIG. 4 shows the rear of the caddy 300. A portion of the foot 316 is located at the bottom of, and on either side of, the back wall 310, with a rectangular opening therebetween. The curved handle 322 extends outwardly and upwards from the back wall 310.

The bottom of the curved handle 322 has a rear and downwardly extending mounting flange 330. The mounting flange 330 has a plurality of mounting apertures 334. Each mounting aperture 334 has circular bottom opening 336 connecting to a half obround slot 340 extending upwardly from the bottom circular opening 336.

If desired, the caddy 300 can be mounted by placing the mounting apertures 334 over a mount (not shown), such as a nail, a hook, or a peg, such that the mount passes through the circular bottom opening 336 and is retained against the upper end of the slot 340. In this way, the caddy 300 may be suspended upon a vertical surface for storage, thus conserving floor space. Alternatively, the mounting flange has a different configuration, the caddy lacks a mounting flange, or the caddy has a different hanging mechanism.

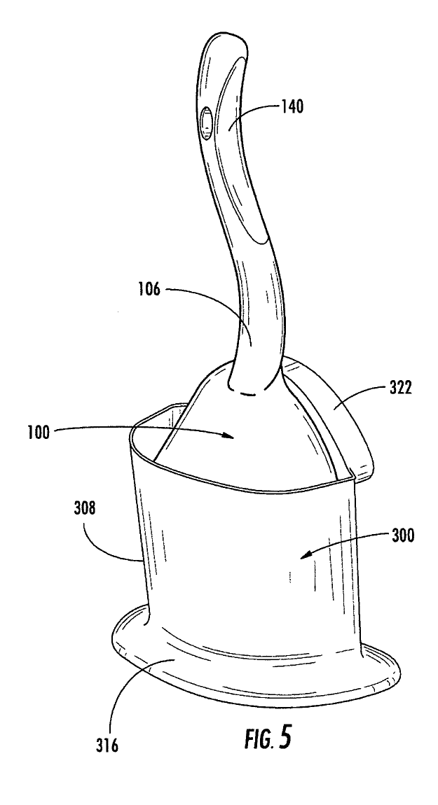

FIG. 5 illustrates the litter scoop 100 of FIG. 1 inserted into the caddy 300 of FIG. 3 for storage. The litter scoop 100 is downwardly inserted into the caddy 300, with the front portion 114 (FIG. 1) facing down. The bottom portion 112 (FIG. 1) is proximate the front wall 308 of the caddy 300. When the caddy 300 is standing on its bottom, the foot 316 provides stability for the caddy 300, helping it resist tipping over.

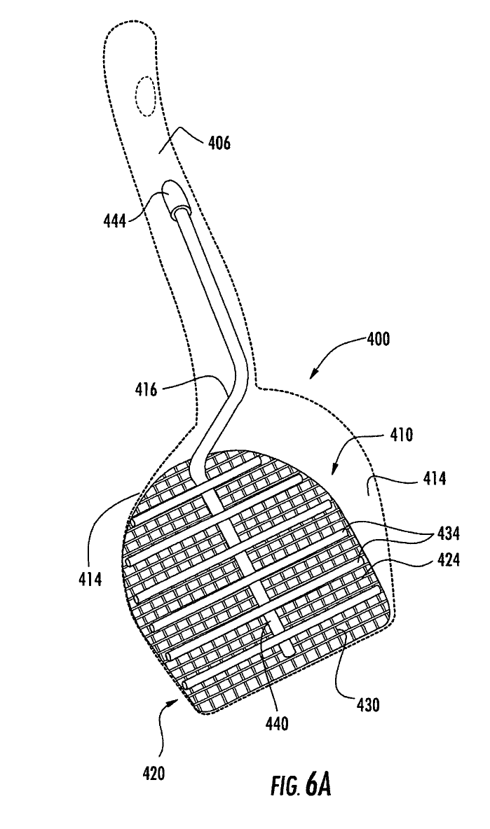

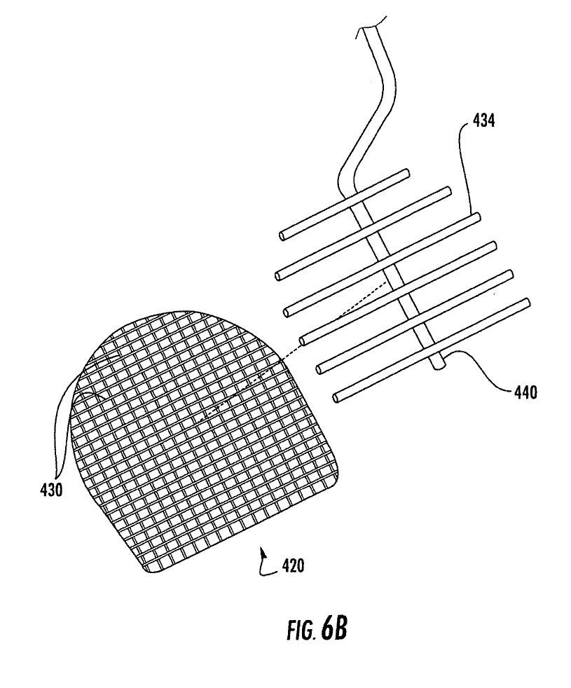

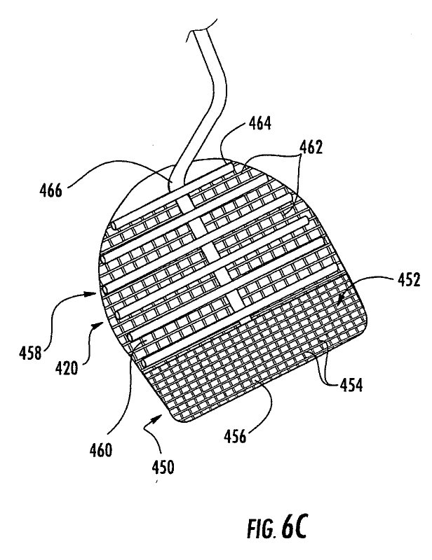

FIG. 6A illustrates a litter scoop 400 having adjustable apertures. The litter scoop 400 has a handle 406 connected to a sifting basket 410. The sifting basket 410 is formed from a bottom portion 420, two sides 414 and a rear wall 416. In certain embodiments one or more of the two sides 414 or the rear wall 416 may be omitted, and other walls can be included.

The bottom portion 420 of the sifting basket 410 includes a plurality of adjustable apertures 424. The adjustable apertures 424 are formed from a plurality of fixed wires 430 and a plurality of adjustable wires 434 in parallel to some of the fixed wires 430. The adjustable wires 434 are connected to a central moveable shaft 440. The shaft 440 is in communication with a moveable lever, or button, 444.

In operation, a user can select the size of the adjustable apertures 424 by actuating the lever 444 such that the adjustable wires 434 move relative to the fixed wires 430. For example, in one implementation, the adjustable apertures 424 may be made smaller by moving the adjustable wires 434 from a position overlapping fixed wires 430 to a position offset from fixed wires 430. Similarly, the adjustable apertures 424 can be made larger by moving the adjustable wires 434 such that the adjustable wires 434 overlap fixed wires 430.

FIG. 6B is an exploded view of the bottom portion 420 of the sifting basket 410. As shown, the adjustable wires 434 are placed on top of a grid of fixed wires 430. A user may adjust the position of the adjustable wires 434 by moving the shaft 440 forward or back. The adjustable apertures 424 are the largest when each adjustable wire 434 is vertically aligned with a corresponding fixed wire 430. From the vertically aligned position, moving the adjustable wires 434 forward or back reduces the size of the adjustable apertures 424.

FIG. 6C illustrates an alternate embodiment of the bottom portion 420 of the sifting basket 410. The bottom portion 420 is divided into a front portion 450 having a mesh 452 of fixed wires 454 forming fixed apertures 456 and a rear portion 458 having adjustable apertures 460. The adjustable apertures 460 are formed from the interaction of fixed wires 462 with adjustable wires 464. The adjustable wires 464 are attached to a moveable shaft 466.

The embodiment of FIG. 6C may be useful, for example, when the fixed apertures 456 are of a relatively small size and the size of the adjustable apertures 460 is selected to provide decreased sifting time (by having relatively larger adjustable apertures 460) or increased fine sifting area (by having relatively smaller adjustable apertures 460). If desired, the front portion 450 and rear portion 458 can be reversed. In addition, more regions of adjustable apertures 460, such as embodiments having two areas of independently adjustable apertures, or fixed apertures 456 can be included, or could be located other than at the front and back of the bottom portion 420, such as on the sides of the bottom portion 420.

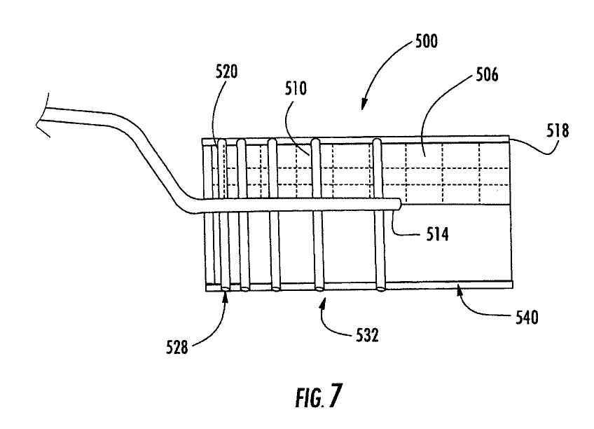

FIG. 7 illustrates a particular embodiment of a litter scoop 500 having adjustable apertures 506 formed by adjustable wires 510. The adjustable wires 510 are connected to a central shaft 514. Each end of the wires 510 may be secured in a track 518 by a pin 520.

The wires 510 may be stored in a compressed state towards the back end 528 of a bottom portion 532 of a sifting basket 536 of the litter scoop 500. When the shaft 514 is moved towards a front portion 540 of the sifting basket 536, the wires 510 are gradually moved towards the front portion 540 of the sifting basket 536. As the wires 510 move forward, they cooperate with fixed wires 546 to reduce the size of apertures 550 formed by the fixed wires 546. Thus, by selecting how far the shaft 514 is actuated, a user may select both the size of the apertures 550 and the extent of the area of the bottom portion 532 of the sifting basket 536 that is affected by the movement of the wires 510.

Although, in FIGS. 6-7, the movable wires are shown perpendicular to the shaft, the movably wires could be positioned differently. For example, the moveable wires can be moved from a compressed state in which they are parallel with the shaft (and therefore, at least in some embodiments, do not affect aperture size), to an expanded state where the moveable wires are not parallel with the shaft (and therefore, at least in some embodiments, do affect aperture size), such as being perpendicular to the shaft 514. The wires 510 may hinged, or have another suitable mechanism, in order to provide a greater range of movement. In another implementation, adjustable apertures may be formed using a fan type mechanism whereby wires are moved from a first position, such a longitudinally aligned position, to a second angular position where the wires are separated.

It is to be understood that the above discussion provides a detailed description of various embodiments. The above descriptions will enable those skilled in the art to make many departures from the particular examples described above to provide apparatuses constructed in accordance with the present disclosure. The embodiments are illustrative, and not intended to limit the scope of the present disclosure. The scope of the present disclosure is rather to be determined by the scope of the claims as issued and equivalents thereto.

We claim:

1. A litter scoop comprising:
(A) a sifting basket comprising:
(i) a bottom having a plurality of first apertures and a plurality of second apertures, each of the first apertures having an area of about 36 mm² or less, and each of the second apertures having an area greater than about 36 mm²;
(ii) an open front portion; and
(iii) one or more sides;
(B) a handle operatively coupled to the sifting basket;
whereby a user may grasp the litter scoop by the handle and move the litter scoop through litter in order to separate used litter and animal waste from unused litter.

2. The litter scoop of claim 1 wherein the first apertures have an area of about 25 mm² or less.

3. The litter scoop of claim 1, wherein the handle is ergonomically curved, the handle comprising a concave portion proximate the sifting basket and a convex portion proximate the end of the handle.

4. The litter scoop of claim 1, wherein the handle comprises an insert portion, the insert portion providing a gripping surface to the user.

5. The litter scoop of claim 4, wherein the insert portion is formed of rubber and the handle is formed of plastic.

6. The litter scoop of claim 4, wherein the insert portion is coupled to a lateral side of the handle and extends to, but not across, top and bottom surfaces of the handle.

7. The litter scoop of claim 1, further comprising a scraper coupled to the sifting basket.

8. The litter scoop of claim 7, wherein at least part of the sifting basket is formed of plastic and the scraper is formed of steel.

9. The litter scoop of claim 1, wherein the first apertures are located at a front portion of the bottom and the second apertures are located at a rear portion of the bottom.

10. The litter scoop of claim 1, the first apertures forming a first mesh and the second apertures forming a second mesh.

11. The litter scoop of claim 10, wherein the first and second meshes are made of wire.

12. The litter scoop of claim 10, wherein the first mesh has a first number of wires per inch and the second mesh has a second number of wires per inch, the first number of wires per inch being larger than the second number of wires per inch.

13. The litter scoop of claim 10, wherein the first and second meshes are formed from a synthetic material.

14. The litter scoop of claim 1, the first and second apertures being at least substantially square.

15. The litter scoop of claim 1, the first and second apertures being round or diamond shaped.

16. The litter scoop of claim 1, wherein the first apertures are located in a first area of the bottom of the sifting basket and the second apertures are located in a second area of the bottom of the sifting basket, the bottom of the sifting basket further comprising a strip separating the first and second areas, the strip being raised above the first and second areas.

17. The litter scoop of claim 1, wherein the one or more sides of the sifting basket include two lateral sides and a back, and wherein the lateral sides and the back of the sifting basket are integrally formed and the bottom is coupled thereto.

18. The litter scoop of claim 1, wherein the first apertures are adapted for fine grain separation of the used litter and the animal waste from the unused litter, and wherein the second apertures are adapted for coarse grain separation of the used litter and the animal waste from the unused litter.

19. A litter scoop comprising:
(A) a sifting basket comprising:
(i) a bottom comprising a first mesh comprising apertures of a first size, the bottom further comprising a second mesh comprising apertures of a second size, the second size being larger than the first size;
(ii) an open front portion; and
(iii) one or more sides;
(B) a handle operatively coupled to the sifting basket;
whereby a user may grasp the litter scoop by the handle and move the litter scoop through litter in order to separate used litter and animal waste from unused litter.

20. The litter scoop of claim 19, wherein the handle is ergonomically curved, the handle comprising a concave portion proximate the sifting basket and a convex portion proximate the end of the handle.

21. The litter scoop of claim 19, wherein the handle comprises an insert portion, the insert portion providing a gripping surface to the user.

22. The litter scoop of claim 21, wherein the insert portion is formed of rubber and the handle is formed of plastic.

23. The litter scoop of claim 21, wherein the insert portion is coupled to a lateral side of the handle and extends to, but not across, top and bottom surfaces of the handle.

24. The litter scoop of claim 19, further comprising a scraper coupled to the sifting basket.

25. The litter scoop of claim 24, wherein at least part of the sifting basket is formed of plastic and the scraper is formed of steel.

26. The litter scoop of claim 19, wherein the first and second meshes are made of wire.

27. The litter scoop of claim 26, wherein the first mesh is formed from wire having a first diameter and the second mesh is formed from wire having a second diameter, the first diameter being smaller than the second diameter.

28. The litter scoop of claim 26, wherein the first mesh has a first number of wires per inch and the second mesh has a second number of wires per inch, the first number of wires per inch being larger than the second number of wires per inch.

29. The litter scoop of claim 19, wherein the first and second meshes are made from a synthetic material.

30. The litter scoop of claim 19, wherein the first size is about 25 mm² and the second size is about 49 mm².

31. The litter scoop of claim 19, wherein the first mesh is adapted for fine grain separation and the second mesh is adapted for coarse grain separation.

32. A litter scoop comprising:
(A) a sifting basket comprising:
(i) a bottom comprising a first size aperture area and a second size aperture area adjacent the first size aperture area, wherein the first size aperture area is adapted for finer separation of used litter and animal waste from unused litter, and wherein the second size aperture area is adapted for coarser separation of the used litter and the animal waste from the unused litter;
(ii) an open front portion; and
(iii) one or more sides;
(B) a handle operatively coupled to the sifting basket;
whereby a user may grasp the litter scoop by the handle and move the litter scoop through litter in order to separate used litter and animal waste from unused litter.

33. A litter scoop caddy comprising:
(A) one or more walls;
(B) a bottom section adjoining at least some of the one or more walls, the one or more walls and the bottom section defining a cavity for receiving a litter scoop; and
(C) a carrying handle coupled to at least one of the one or more walls, whereby the carrying handle may be used to transport the litter scoop caddy.

34. The litter scoop caddy of claim 33, further comprising a mounting flange coupled to a back wall of the one or more walls.

35. The litter scoop caddy of claim 33, further comprising a mounting flange coupled to the carrying handle.

36. The litter scoop caddy of claim 35, the mounting flange defining at least one mounting aperture, whereby a mount may be inserted through the mounting aperture.

37. The litter scoop caddy of claim 33, the carrying handle comprising a gripping section formed on an inside portion of the carrying handle.

38. The litter scoop caddy of claim 37, the gripping section comprising one or more semicircular indentions.

39. A litter scoop comprising:
(A) a sifting basket comprising:
(i) a bottom;
(ii) a metal scraping edge attached to the bottom;
(iii) an open front portion; and
(iv) one or more sides raised above the bottom;
(B) a handle operatively coupled to the sifting basket;
whereby a user may grasp the litter scoop by the handle and move the litter scoop through litter in order to separate used litter and animal waste from unused litter.

40. The litter scoop of claim 39, wherein the bottom comprises a plastic portion and the metal scraping edge is coupled to the plastic portion.

41. The litter scoop of claim 39, wherein the metal scraping edge is smooth.

42. The litter scoop of claim 39, wherein the metal scraping edge is serrated.

43. A litter scoop comprising:
(A) a sifting area;
(B) a handle operatively coupled to the sifting area; and
(C) a grip coupled to a side of the handle;
whereby a user may grasp the litter scoop by the handle and move the litter scoop through litter in order to separate used litter and animal waste from unused litter.

44. The litter scoop of claim 43, wherein the grip is made from a soft plastic or rubber material.

45. The litter scoop of claim 43, wherein the grip does not extend across at least one of the top and bottom surfaces of the handle.

46. The litter scoop of claim 43, wherein the grip is curved.

47. A method of sifting litter with a litter scoop comprising a first sifting area adapted to retain small pieces of waste and a second sifting area adapted to retain large pieces of waste, the method comprising:
inserting the litter scoop into a quantity of litter such that at least a portion of the litter contacts the first sifting area of the litter scoop to retain small pieces of waste; and
tilting the litter scoop backward and moving the litter scoop from side to side and/or up and down to sift unused litter.

48. The method of claim 47, wherein the tilting and the moving cause the second sifting area to retain large pieces of waste.

49. The litter sifting method of claim 47, wherein the litter is selectively contacted with the first sifting area during the inserting such that the litter substantially does not contact the second sifting area during the inserting.
